(19) United States
(12) Patent Application Publication
(10) Pub. No.: US 2023/0407140 A1
(43) Pub. Date: Dec. 21, 2023

(54) PRINTABLE FILMS

(71) Applicant: Avery Dennison Corporation, Mentor, OH (US)

(72) Inventors: GuangXue WEI, Buffalo Grove, IL (US); Nikhil R. AGASHE, Naperville, IL (US)

(21) Appl. No.: 18/251,733

(22) PCT Filed: Oct. 7, 2021
(86) PCT No.: PCT/US2021/053891

§ 371 Date: May 4, 2023

Related U.S. Application Data
(60) Provisional application No. 63/114,593, filed on Nov. 17, 2020.

(51) Int. Cl. C09J 7/29; B41M 5/50; G09F 13/16; C09J 7/38

(52) U.S. Cl. CPC C09J 7/29; B41M 5/502; G09F 13/16; C09J 7/38; B44F 1/04

(57) ABSTRACT

Printable films, such as retroreflective, graphic and label film materials, comprising a substrate layer, which is formed from a composition comprising a polymethyl methacrylate and an acrylic copolymer comprising hard segments and soft segments, and products formed therefrom are disclosed. Methods of improving print quality of a printable are also disclosed.

### CROSS-REFERENCE TO RELATED APPLICATION(S)

The present application claims the benefit of U.S. Provisional Patent Application No. 63/114,593 filed Nov. 17, 2020, which is incorporated herein by reference in its entirety.

### FIELD OF THE INVENTION

The invention relates generally to printable films. More specifically, the invention relates to printable films, such as retroreflective, graphic, and label film materials, with improved print quality, products formed from the printable films, and methods of improving the print quality of the printable films.

### BACKGROUND OF THE INVENTION

Polymethyl methacrylate (“PMMA”) is an amorphous thermoplastic polymer with high glass transition temperature (about 105° C.), good mechanical properties, and excellent weatherability. It is resistant to oils, alkanes, and diluted acids but is not resistant to many polar solvents such as alcohols, organic acids, and ketones. It is somewhat brittle and has low impact strength and fatigue resistance. To increase its toughness, PMMA is often modified with core-shell rubber or other impact modifier. Impact modifiers can offer a tenfold increase in impact resistance of the PMMA while still maintaining high clarity of the final product.

Because of their high transparency (92% transmission), toughened PMMA and related acrylics are used as lightweight and shatter-resistant replacements for silicate glass. Due to their impact resistance, these resins can be machined.

PMMA is also used in film applications, such as reflective films, graphic films, and retroreflective films. In these applications, the film is often printed. When solvent or eco-solvent inks are used, the color clarity and color uniformity after printing can be problematic. When ultraviolet (“UV”) inks are used, ink adhesion to the top surface of the film can be problematic.

It would be desirable to have a printable film (either as a single layer or as the top layer in a multilayer system) that is printable with either solvent/eco-solvent inks or UV inks without detracting from the clarity of the film. The invention is directed to these, as well as other, important needs.

### SUMMARY OF THE INVENTION

Accordingly, in one aspect, the invention is directed to printable films, comprising a composition, wherein the composition comprises: an polymethyl methacrylate material; and an acrylic copolymer comprising hard segments and soft segments; wherein the hard segments comprise polymerized residues of methyl methacrylate; and wherein the soft segments comprise polymerized residues of a monomer whose homopolymer has a glass transition temperature less than about 50° C., preferably less than about 0° C., more preferably less than about −20° C., and even more preferably less than about −40° C.

In another aspect, the invention is directed to retroreflective sheets, comprising: a first layer comprising the printable film described herein; and a second layer disposed on the first layer; wherein the second layer comprises: a plurality of retroreflective elements.

In further aspects, the invention is directed to retroreflective signs, comprising: a sign blank; the retroreflective sheet described herein; wherein the retroreflective sheet is applied to the sign blank; and wherein the retroreflective sheet further comprises: printed indicia on the first layer; and a pressure sensitive adhesive located on the second layer on a side opposite to the first layer.

In yet other aspects, the invention is directed to methods of improving print quality of a printable film, comprising the steps: providing a composition comprising: an polymethyl methacrylate material; and an acrylic copolymer comprising hard segments and soft segments; wherein the hard segments comprise polymerized residues of methyl methacrylate; and wherein the soft segments comprise polymerized residues of a monomer whose homopolymer has a glass transition temperature less than about 50° C.; and forming a film from the composition.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIGS. 1A and 1B are cross-section views of illustrative embodiments of printable films of the invention.

FIG. 2 is a cross-section view of one illustrative embodiment of a retroreflective sheet of the invention, where the retroreflective elements are micro prisms.

FIG. 3 is a cross-section view of one illustrative embodiment of a retroreflective sheet of the invention, where the retroreflective elements are micro beads.

FIG. 4 is a cross-section view of one illustrative embodiment of a retroreflective sign of the invention, where the retroreflective elements are micro prisms.

FIG. 5 is a cross-section view of one illustrative embodiment of a retroreflective sign of the invention, where the retroreflective elements are micro beads.

### DETAILED DESCRIPTION OF THE ILLUSTRATED EMBODIMENTS

### Definitions

As employed above and throughout the disclosure, the following terms, unless otherwise indicated, shall be understood to have the following meanings.

As used herein, the terms “comprises,” “comprising,” “includes,” “including,” “has,” “having” or any other variation thereof, are intended are open-ended and cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” is employed to describe elements and components described herein. This is done merely for convenience and to give a general sense of the scope of the invention. This description should be read to include “one” or “at least one” and the singular also includes the plural, unless it is obvious that it is meant otherwise by the context. As used herein, the term “about,” when referring to a measurable value such as an amount, a temporal duration, and the like, is meant to encompass variations of ±10%, preferably, ±8%, more preferably, ±5%, even more preferably, ±1%, and yet even more preferably, ±0.1% from the specified value, as such variations are appropriate to perform the disclosed methods.

As used herein, the term “glass transition temperature” or “T_{g},” as used in connection with the homopolymers for the purposes of this invention are those reported in “Polymer Handbook”, edited by J. Brandrup and E. H. Immergut, Interscience Publishers, 1966, unless that publication does not report the T_{g} of a particular homopolymer, in which case the T_{g} of the homopolymer is measured by differential scanning calorimetry (DSC) at a heating rate of at a heating rate of 10° K/minute.

As used herein, the term “triblock copolymer,” refers to a block copolymer of the structure of A-B-A, where A is a hard (higher T_{g}) segment and B is a soft (lower T_{g}) segment.

As used herein, the term “diblock copolymer,” refers to a block copolymer of the structure of A-B, where A is a hard (higher T_{g}) segment and B is a soft (lower T_{g}) segment.

As used herein, the term “print quality” means printing that exhibits acceptable color clarity, color uniformity, and ink adhesion to a substrate, especially for a variety of colors, including but not limited to, red, yellow, green, blue, and black.

As used herein, the term “retroreflective” means a surface, material, or device (retroreflector) that reflects light or other radiation back to its source.

As used herein, the term “sheet” means a two-dimensional piece of paper, fabric, plastic, or similar material configured to be attached to an object and giving information about it and/or decoration to it. The sheet may be any suitable shape or design, such as, for example, rectangular, square, circular, oval, triangular, multisided and irregular shapes. The sheet may have edges and corners that are sharp, rounded, or irregular.

As used herein, the term “sign” means a two-dimensional piece of paper, fabric, plastic, or similar material configured to be attached to an object and giving information about it and/or decoration to it. The label may be any suitable shape or design, such as, for example, rectangular, square, circular, oval, triangular, multisided and irregular shapes. The label may have edges and corners that are sharp, rounded, or irregular.

As used herein, “pressure sensitive adhesive” or “PSA” refers to a material that may be identified by the Dahlquist criterion, which defines a pressure sensitive adhesive as an adhesive having a one second creep compliance of greater than 1×10⁻⁶ cm²/dyne as described in Handbook of PSA Technology, Donatas Satas (Ed.), 2^{nd} Edition, page 172, Van Nostrand Reinhold, New York, N.Y., 1989. Since modulus is, to a first approximation, the inverse of creep compliance, pressure sensitive adhesives may also be defined as adhesives having a Young's modulus of less than 1×10⁶ dynes/cm². Another well-known means of identifying a pressure sensitive adhesive is an adhesive that it is aggressively and permanently tacky at room temperature and firmly adheres to a variety of dissimilar surfaces upon mere contact without the need of more than finger or hand pressure, and which may be removed from smooth surfaces without leaving a residue, as described in Glossary of Terms Used in the Pressure Sensitive Tape Industry provided by the Pressure Sensitive Tape Council, 1996. Another suitable definition of a suitable pressure sensitive adhesive is that it preferably has a room temperature storage modulus within the area defined by the following points as plotted on a graph of modulus versus frequency at 25° C.: a range of moduli from about 2×10⁵ to 4×10⁵ dynes/cm² at a frequency of about 0.1 radians/sec (0.017 Hz), and a range of moduli from about 2×10⁶ to 8×10⁶ dynes/cm² at a frequency of approximately 100 radians/sec (17 Hz). See, for example, Handbook of PSA Technology (Donatas Satas, Ed.), 2^{nd} Edition, page 173, Van Nostrand Rheinhold, N.Y., 1989. Any of these methods of identifying a pressure sensitive adhesive may be used to identify suitable pressure sensitive adhesives for use in the labels of the invention. Pressure sensitive adhesives are permanently tacky in dry form and can firmly adhere to a substrate with very light pressure. The adhesive requires no activation by solvent, water, or heat to exert sufficient holding power.

As used herein, the phrase “release liner” means film sheet (typically paper or polymeric film, usually applied during the manufacturing process) used to prevent a sticky surface from prematurely adhering. It is coated on one or both sides with a release agent, which provides a release effect against any type of a sticky material, such as an adhesive or a mastic.

As used herein, the phrase “printed indicia” means any alphanumeric, special characters, shape, symbol or imaged used to convey information and/or provide aesthetic appeal. The indicia may be printed in any suitable means including printing by hand, typewriter, or convention printing (such as flexographic printing, offset printing, inkjet printing, laser inkjet printing, videojet printing, thermal transfer, direct printing, gravure printing, and the like) using any suitable ink (such as solvent-based inks and UV-curable inks).

### Printable Films

While not wishing to be bound by theory, it is believed that in impact-modified PMMA systems there is an interphase separation between the PMMA matrix and impact modifier rubber particles due to solvents in the inks attacking and dissolving the rubber particles, which are not resistant to the solvents used in the printing inks. It is also believed that by blending block copolymer with the impact-modified PMMA system, the interphase between the PMMA and impact modifier rubber particles is strengthened and rubber particles are more evenly distributed, resulting in greater solvent resistance. It is further believed that the addition of the block copolymer helps absorb the printing ink and the solvent, thereby preventing the solvent attack of the impact modifier rubber particles, providing more uniform ink distribution.

Accordingly, in one aspect, the invention is directed to printable films, comprising a composition, wherein the composition comprises: a polymethyl methacrylate material; and an acrylic copolymer comprising hard segments and soft segments; wherein the hard segments comprise polymerized residues of methyl methacrylate; and wherein the soft segments comprise polymerized residues of a monomer whose homopolymer has a glass transition temperature less than about 50° C., preferably less than about 0° C., more preferably less than about −20° C., and even more preferably less than about −40° C.

The composition may optionally contain additives, such as, for example, colorants (dyes or pigments), UV absorbers and/or hindered amine light (to improve durability).

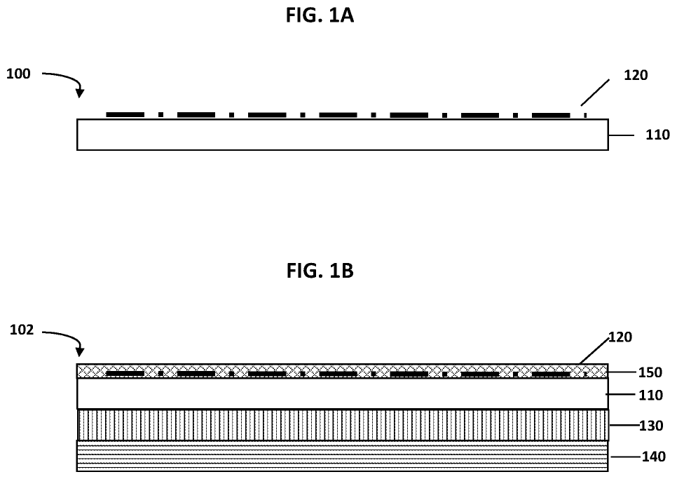

FIG. 1A is a cross-section view of one illustrative embodiment of a printable film of the invention. The printable film 100 is shown as a single film layer 110. A multilayer is possible where the printable film layer is the top layer prior to printing. Printed indicia 120 is shown printed on the printable film layer 110.

FIG. 1B is a cross-section view of another illustrative embodiment of a printable film of the invention. The printable film 102 is shown as a single film layer 110. Printed indicia 120 is shown printed on the printable film layer 110. An optional overlaminate layer 150 covers the printed indicia 120 after the printable film layer 110 is printed. An optional adhesive layer 130 with an optional release liner 140 is shown on the side opposite to the printed side of the printable film layer 110.

In certain embodiments of the printable film, the hard segments have a T_{g} of about 100° C. to about 120° C. In certain embodiments of the printable film, the soft segments have a T_{g} of about −40° C. to about −60° C.

In certain embodiments of the printable film, the polymethyl methacrylate material is a polymethyl methacrylate homopolymer, a polymethyl methacrylate copolymer, an impact-modified version thereof, or a combination thereof. In the polymethyl methacrylate copolymer, the residues of the methyl methacrylate are present at a level of at least about 80% by weight, based on the total weight of the copolymer.

In certain embodiments of the printable film, the the soft segments comprise polymerized residues of a monomer selected from the group consisting of butyl acrylate, 2-ethylhexyl acrylate, and combinations thereof.

In certain embodiments of the printable film, the acrylic copolymer is present at a level of about 2% by weight, based on the total weight of the composition, to about 40% by weight, based on the total weight of the composition. Preferably, the acrylic copolymer is present at a level of about 5% by weight, based on the total weight of the composition, to about 20% by weight, based on the total weight of the composition. More preferably, the acrylic copolymer is present at a level of about 5% by weight, based on the total weight of the composition, to about 15% by weight, based on the total weight of the composition.

In certain embodiments of the printable film, the acrylic copolymer is a block copolymer of methyl methacrylate and butyl acrylate.

In certain embodiments of the printable film, the hard segments are present in the acrylic copolymer at a level of about 35% by weight, based on the total weight of the acrylic copolymer, to about 55% by weight, based on the total weight of the acrylic copolymer.

In certain embodiments of the printable film, the acrylic copolymer is a tri-block copolymer. In other embodiments, the acrylic copolymer is a di-block copolymer.

In certain embodiments of the printable film, the acrylic copolymer is non-crystalline.

### Retroreflective Sheets

In another aspect, the invention is directed to retroreflective sheets, comprising: a first layer comprising the printable film described herein; and a second layer disposed on the first layer; wherein the second layer comprises: a plurality of retroreflective elements.

In certain embodiments, the retroreflective sheet further comprises: a pressure sensitive adhesive located on the second layer on a side opposite to the first layer; and an optional release liner on the pressure sensitive adhesive.

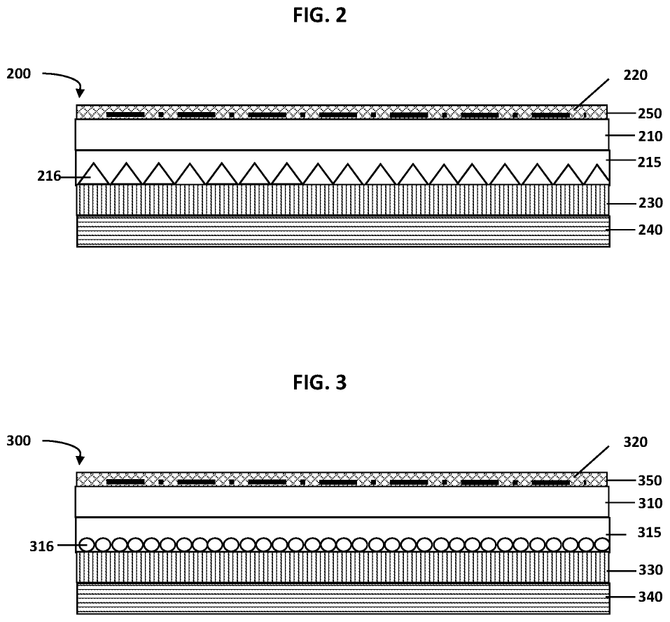

FIG. 2 is a cross-section view of one illustrative embodiment of a retroreflective sheet of the invention, where the retroreflective elements are micro prisms. The retroreflective sheet 200 is shown as a multilayer film (with printable film layer 210 and second layer 215 containing retroreflective elements (here as micro prisms 216). Printed indicia 220 is shown printed on the printable film layer 210.

An optional overlaminate layer 250 covers the printed indicia 220 after the printable film layer 210 is printed. An optional adhesive layer 230 with an optional release liner 240 is shown on the side opposite to the printed side of the printable film layer 210.

FIG. 3 is a cross-section view of one illustrative embodiment of a retroreflective sheet of the invention, where the retroreflective elements are micro beads. The retroreflective sheet 300 is shown as a multilayer film (with printable film layer 310 and second layer 315 containing retroreflective elements (here as micro beads 316). Printed indicia 320 is shown printed on the printable film layer 310. An optional overlaminate layer 350 covers the printed indicia 320 after the printable film layer 310 is printed. An optional adhesive layer 330 with an optional release liner 340 is shown on the side opposite to the printed side of the printable film layer 310.

The release liners that may be utilized in the retroreflective sheet of the invention may contain any of a variety of materials known to those of skill in the art to be suitable as release liners. In one embodiment, the release liner contains or is a 90 #stayflat liner. Other suitable release liners include silicone coated films or polycoated kraft paper, as are known in the art. Suitable pre-siliconized release liners are available commercially. The release liner may be flat or structured. Specialized liners, including those that provide air egress through structures and channels in the pressure sensitive adhesive, may preferably be used. Suitable air egress release liners are those sold under the EZApply and EZRS brand names by Avery Dennison Corporation.

In certain embodiments, the retroreflective sheet further comprises: printed indicia on the printable layer; and an optional overlaminate layer provided over at a portion of the printed indicia, where the overlaminate layer comprises a clear polymeric film and a removable pressure sensitive adhesive.

In certain embodiments of the retroreflective sheet, the plurality of retroreflective elements are micro prisms. The retroreflective elements may be prepared of any suitable material, including, for example, PMMA, polycarbonate, or a combination thereof. In some embodiments, the retroreflective elements are shapes selected from a group consisting of triangles, squares, rectangles, hexagons, and combinations thereof.

In certain embodiments of the retroreflective sheet, the plurality of retroreflective elements are micro beads.

### Retroreflective Signs

In further aspects, the invention is directed to retroreflective signs, comprising: a sign blank (which may be, for example, metal, such as aluminum, plastic, wood, or a composite); the retroreflective sheet described herein; wherein the retroreflective sheet is applied to the sign blank; and wherein the retroreflective sheet further comprises: printed indicia on the first layer; and a pressure sensitive adhesive located on the second layer on a side opposite to the first layer.

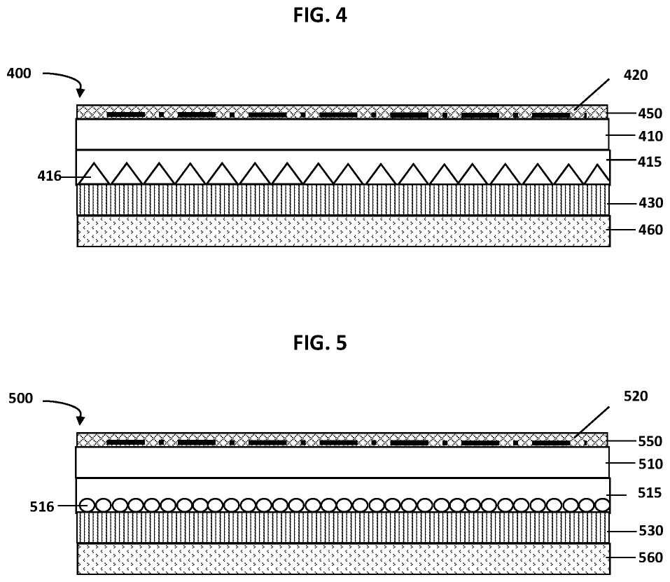

FIG. 4 is a cross-section view of one illustrative embodiment of a retroreflective sign of the invention, where the retroreflective elements are micro prisms. The retroreflective sign 400 is shown as a multilayer film (with printable film layer 410 and second layer 415 containing retroreflective elements (here as micro prisms 416). Printed indicia 420 is shown printed on the printable film layer 410. An optional overlaminate layer 450 covers the printed indicia 420 after the printable film layer 410 is printed. An adhesive layer 430 is attached to a sign blank 460 is shown on the side opposite to the printed side of the printable film layer 410.

FIG. 5 is a cross-section view of one illustrative embodiment of a retroreflective sign of the invention, where the retroreflective elements are micro beads. The retroreflective sign 500 is shown as a multilayer film (with printable film layer 510 and second layer 515 containing retroreflective elements (here as micro beads 516). Printed indicia 520 is shown printed on the printable film layer 510. An optional overlaminate layer 550 covers the printed indicia 520 after the printable film layer 510 is printed. An adhesive layer 530 is attached to a sign blank 560 is shown on the side opposite to the printed side of the printable film layer 510.

### Methods of Improving Print Quality

In yet other aspects, the invention is directed to methods of improving print quality of a printable film, comprising the steps: providing a composition comprising: an polymethyl methacrylate material; and an acrylic copolymer comprising hard segments and soft segments; wherein the hard segments comprise polymerized residues of methyl methacrylate; and wherein the soft segments comprise polymerized residues of a monomer whose homopolymer has a glass transition temperature less than about 50° C., preferably less than about 0° C., more preferably less than about −20° C., and even more preferably less than about −40° C.; and forming a film from the composition.

The present invention is further defined in the following Examples, in which all parts and percentages are by weight, unless otherwise stated. It should be understood that these examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various usages and conditions.

### EXAMPLES

The following test methods were used to evaluate exemplary embodiments and comparative materials, unless otherwise noted.

For evaluating printability, color clarity, color uniformity, and ink adhesion tests were used. Printing issues with solvent or eco-solvent inks are different those experienced with UV inks. For solvent and eco-solvent inks, color clarity and color uniformity of the printed indicia are often problems. For UV inks, the ink adhesion to the top surface of the film is often a problem.

Color clarity: This test is done via visual inspection of the dried ink on the printed sheet by the human eye without any specialized measuring equipment looking for haziness. A scale of 0-5 was used to indicate color clarity (0=worst; 5=perfect; 3 and 4 are acceptable; 1 and 2 are not acceptable; X=not applicable).

Color uniformity: This test is done via visual inspection of the dried ink on the printed sheet by the human eye without any specialized measuring equipment looking for non-uniform distribution of the color (such as areas where the color is dark and other areas where the color is light). A scale of 0-5 was used to indicate color uniformity (0=worst; 5=perfect; 3 and 4 are acceptable; 1 and 2 are not acceptable).

Ink adhesion: This test measures the bonding strength of the ink with printed substrate, as evaluated using ASTM D3359-02 test method (Test Method B). A scale of 0B-5B was used to indicate bonding strength (0B=no bonding at all; 5B=perfect bonding; 3B and 4B acceptable; 1B and 2B are not acceptable). For solvent ink printing, the ink adhesion is generally not a problem. However, for UV ink printing, the ink adhesion is often problematic, while clarity and color uniformity are generally not problematic.

Haze may also be used to evaluate color clarity and is measurable. Haziness is caused by micro-cracking and/or phase separation in the material. Also reflectivity, which like haze is measurable, is indicative of clarity. For same color chromaticity (x, y), better clarity (less haze) gives better reflectivity for retroreflective sheeting.

Reflectivity: This test measures reflectivity in accordance with ASTM D4956-19 test method.

The blend compositions evaluated in the examples were made using a C. W. Brabender Plasti-Corder Prep-Mixer. The acrylic blend compositions were compounded through melt mixing of polymer resins and other components and then converted into films of about 2-4 mils using a heated platen press (Carver press). The mixing temperature was about 230° C. and the mixing speed was 100 rpm for mixing time about 3-5 minutes. After the films were pressout using the Carver press, the pressout films as an out layer film with a PMMA or a polycarbonate film layer as prism layer were embossed into retroreflective film using an embosser.

After the converted retroreflective films prepared, each was printed using Avery Dennison TrafficJet printers (TrafficJet Plus for solvent inks and TrafficJet Pro for UV curable inks) to test printing quality. The printing quality was judged as color clarity, color uniformity, ink adhesion, and reflectivity for different color inks. Rating ranking: 5 or 5B=perfect; 3=acceptable.

In the following examples, the impact-modified PMMA used were:
OPTIX® CA-1000 E-2 from Plaskolite;
ALTUGLAS® DR-101 from Arkema (50-54% by weight, based on total weight of product, of ethyl acrylate/methyl methacrylate copolymer with 35-50% by weight, based on total weight of product, of acrylic-styrene copolymer impact modifier);
PMMA JG2020-3-1 from Arkema.

The acrylic block copolymers (A-B-A type or A-B type copolymers where A is hard block and B is soft block) used were:
KURARITY™ LA4285 (tri-block copolymer; hard blocks=PMMA (Tg=100-120° C.); soft block=PnBA (Tg=−40-−50° C.)) from Kuraray; and
KURARITY™ LA2270 (tri-block copolymer; hard blocks=PMMA (Tg=100-120° C.); soft block=PnBA (Tg=−40-−50° C.)) from Kuraray.

UV absorber is Tinuvin 360 from BASF (added to improve durability).

### Example 1

JG-1 is an PMMA JG2020-3-1 from Arkema with no acrylic block copolymer or other additive added.

TJ-10 is a blend of 89.5% experimental grade PMMAJG2020-3-1 with 10% Kurarity LA4285 and 0.5% UV absorber (Tinuvin 360).

| | | | | | Ink |
|---|---|---|---|---|---|
| | Formulation/ | Printed | Color | Color | Adhe- |
| Printer/Ink | Substrate | Color | Clarity | Uniformity | sion |
| TJ Plus/Eco- | JG-1 | Yellow | 3 | 2 | 5B |
| Solvent Inks | (comparative) | | | | |
| TJ Plus/Eco- | JG-1 | Red | 3 | 3 | 5B |
| Solvent Inks | (comparative) | | | | |
| TJ Plus/Eco- | JG-1 | Green | 2 | 3 | 5B |
| Solvent Inks | (comparative) | | | | |
| TJ Plus/Eco- | JG-1 | Black | X | 5 | 5B |
| Solvent Inks | (comparative) | | | | |
| TJ Plus/Eco- | TJ-10 | Yellow | 5 | 5 | 5B |
| Solvent Inks | | | | | |
| TJ Plus/Eco- | TJ-10 | Red | 5 | 5 | 5B |
| Solvent Inks | | | | | |
| TJ Plus/Eco- | TJ-10 | Green | 5 | 5 | 5B |
| Solvent Inks | | | | | |
| TJ Plus/Eco- | TJ-10 | Blue | 5 | 5 | 5B |
| Solvent Inks | | | | | |
| TJ Plus/Eco- | TJ-10 | Black | X | 5 | 5B |
| Solvent Inks | | | | | |
| TJ Pro/UV | JG-1 | Yellow | 5 | 5 | 1B |
| Curable Inks | (comparative) | | | | |
| TJ Pro/UV | JG-1 | Red | 5 | 5 | 1B |
| Curable Inks | (comparative) | | | | |
| TJ Pro/UV | JG-1 | Green | 5 | 5 | 1B |
| Curable Inks | (comparative) | | | | |
| TJ Pro/UV | JG-1 | Black | X | 5 | 1B |
| Curable Inks | (comparative) | | | | |
| TJ Pro/UV | TJ-10 | Yellow | 5 | 5 | 5B |
| Curable Inks | | | | | |
| TJ Pro/UV | TJ-10 | Red | 5 | 5 | 5B |
| Curable Inks | | | | | |
| TJ Pro/UV | TJ-10 | Green | 5 | 5 | 5B |
| Curable Inks | | | | | |
| TJ Pro/UV | TJ-10 | Blue | 5 | 5 | 5B |
| Curable Inks | | | | | |
| TJ Pro/UV | TJ-10 | Black | X | 5 | 4B |
| Curable Inks | | | | | |

Example 1 shows the improved printability of both Eco-solvent inks and UV curable inks for PMMA blended with an acrylic copolymer. The addition of LA4285 is greatly improving the printed ink clarity and uniformity for solvent inks and ink adhesion for UV curable inks for different color inks.

### Example 2

T-6500 Reflex (comparative) is an Avery Dennison product that shows good printability for both inks. It is a multilayer film with an inner layer of impact-modified PMMA with top layer of an acrylic copolymer with no impact modifier.

TJ-13 (comparative) is a blend of 99% CA-1000E-2 PMMA with impact modifier with 1% Tinuvin 360 UV absorber and no other additives.

TJ-12 is a blend of 89% CA-1000E-2 PMMA with impact modifier with 10% Kurarity LA4285 acrylic copolymer and 1.0% Tinuvin 360 UV absorber.

| | | | | | Ink |
|---|---|---|---|---|---|
| | Formulation/ | Printed | Color | Color | Adhe- |
| Printer/Ink | Substrate | Color | Clarity | Uniformity | sion |
| TJ Plus/Eco- | T-6500 Reflex | Yellow | 4 | 5 | 5B |
| Solvent Inks | (comparative) | | | | |
| TJ Plus/Eco- | T-6500 Reflex | Red | 4 | 5 | 5B |
| Solvent Inks | (comparative) | | | | |
| TJ Plus/Eco- | T-6500 Reflex | Green | 5 | 5 | 5B |
| Solvent Inks | (comparative) | | | | |
| TJ Plus/Eco- | T-6500 Reflex | Black | X | 5 | 5B |
| Solvent Inks | (comparative) | | | | |
| TJ Plus/Eco- | TJ-13 | Yellow | 3 | 4 | 5B |
| Solvent Inks | (comparative) | | | | |
| TJ Plus/Eco- | TJ-13 | Red | 3 | 4 | 5B |
| Solvent Inks | (comparative) | | | | |
| TJ Plus/Eco- | TJ-13 | Green | 4 | 5 | 5B |
| Solvent Inks | (comparative) | | | | |
| TJ Plus/Eco- | TJ-13 | Blue | 5 | 5 | 5B |
| Solvent Inks | (comparative) | | | | |
| TJ Plus/Eco- | TJ-13 | Black | X | 5 | 5B |
| Solvent Inks | (comparative) | | | | |
| TJ Plus/Eco- | TJ-12 | Yellow | 5 | 5 | 5B |
| Solvent Inks | | | | | |
| TJ Plus/Eco- | TJ-12 | Red | 5 | 5 | 5B |
| Solvent Inks | | | | | |
| TJ Plus/Eco- | TJ-12 | Green | 5 | 5 | 5B |
| Solvent Inks | | | | | |
| TJ Plus/Eco- | TJ-12 | Blue | 5 | 5 | 5B |
| Solvent Inks | | | | | |
| TJ Plus/Eco- | TJ-12 | Black | X | 5 | 5B |
| Solvent Inks | | | | | |
| TJ Pro/UV | T-11500 Reflex | Yellow | 5 | 5 | 5B |
| Curable Inks | (comparative) | | | | |
| TJ Pro/UV | T-11500 Reflex | Red | 5 | 5 | 5B |
| Curable Inks | (comparative) | | | | |
| TJ Pro/UV | T-11500 Reflex | Green | 5 | 5 | 5B |
| Curable Inks | (comparative) | | | | |
| TJ Pro/UV | T-11500 Reflex | Blue | 5 | 5 | 5B |
| Curable Inks | (comparative) | | | | |
| TJ Pro/UV | T-11500 Reflex | Black | X | 5 | 5B |
| Curable Inks | (comparative) | | | | |
| TJ Pro/UV | TJ-13 | Yellow | 5 | 5 | 0 |
| Curable Inks | (comparative) | | | | |
| TJ Pro/UV | TJ-13 | Red | 5 | 5 | 5B |
| Curable Inks | (comparative) | | | | |
| TJ Pro/UV | TJ-13 | Green | 5 | 5 | 0 |
| Curable Inks | (comparative) | | | | |
| TJ Pro/UV | TJ-13 | Blue | 5 | 5 | 0 |
| Curable Inks | (comparative) | | | | |
| TJ Pro/UV | TJ-13 | Black | X | 5 | 5B |
| Curable Inks | (comparative) | | | | |
| TJ Pro/UV | TJ-12 | Yellow | 5 | 5 | 5B |
| Curable Inks | | | | | |
| TJ Pro/UV | TJ-12 | Red | 5 | 5 | 5B |
| Curable Inks | | | | | |
| TJ Pro/UV | TJ-12 | Green | 5 | 5 | 5B |
| Curable Inks | | | | | |
| TJ Pro/UV | TJ-12 | Blue | 5 | 5 | 5B |
| Curable Inks | | | | | |
| TJ Pro/UV | TJ-12 | Black | X | 5 | 5B |
| Curable Inks | | | | | |

Example 2 showed the improved printability of both Eco-solvent inks and UV curable inks for PMMA blended with an acrylic copolymer. The addition of LA4285 greatly improved the printed ink clarity and uniformity for solvent inks and ink adhesion for UV curable inks for different color inks.

The blends of the invention demonstrated greatly improved reflectivity in the resulting retroreflective film after printing for solvent inks with different colors.

The improved printability was demonstrated by printed color quality and retroreflectivity as shows in the following examples.

### Example 3

T-6500 Reflex (comparative) is an Avery Dennison product that shows good printability for both inks. It is a multilayer film with an inner layer of impact-modified PMMA with top layer of an acrylic copolymer with no impact modifier.

JG-1 (comparative) is PMMA JG2020-3-1 from Arkema with no acrylic block copolymer or other additive added.

TJ-11 is a blend of 84% experimental grade PMMA JG2020-3-1 with 15% Kurarity LA4285 and 1.0% UV absorber (Tinuvin 360).

After the compound converted into retroreflective sheets, Eco-solvent ink printing was performed using an Avery Dennison TrafficJet Plus printer. The color and reflectivity was measured after laminating an OL-2000 series acrylic transparent Overlay film from Avery Dennison Corporation on the top of printing layer. For a reference, T-6500 Reflex film was also tested as a comparative. The color (in CIE chromaticity coordinates) and brightness (the luminance factor, Y) were measured for each sample using ColorFlex EZ spectrophotometer from Hunter Lab. The reflectivity of each sample was measured using a photometer. The contrast factor is the ratio of reflectivity after color printing to the reflectivity before printing. A higher contrast factor indicates a better printing quality for the same color.

| | | | | | Daytime | | |
|---|---|---|---|---|---|---|---|
| | | | | | Luminance | | |
| | | | Average | | Factor | CIE Color | |
| | Formulation/ | Printed | Ra | Contrast | (Y) | Coordinates | |
| Printer/Ink | Substrate | Color | (cd/lux/m²) | % | Y | x | y |
| No printing | T-6500 Reflex | None | 952 | | 35.34 | 0.2997 | 0.3194 |
| | (comparative/ | | | | | | |
| | control) | | | | | | |
| No printing | JG-1 | None | 905 | | 37.78 | 0.3027 | 0.3232 |
| | (comparative/ | | | | | | |
| | control) | | | | | | |
| No printing | TJ-11 | None | 862 | | 36.36 | 0.3027 | 0.3237 |
| | (control) | | | | | | |
| TJ Plus/ | T-6500 Reflex | Yellow | 547 | 57 | 22.39 | 0.4756 | 0.4609 |
| Eco- | (comparative) | | | | | | |
| Solvent | | | | | | | |
| Inks | | | | | | | |
| TJ Plus/ | JG-1 | Yellow | 434 | 48 | 25.84 | 0.4682 | 0.4635 |
| Eco- | (comparative) | | | | | | |
| Solvent | | | | | | | |
| Inks | | | | | | | |
| TJ Plus/ | TJ-11 | Yellow | 597 | 69 | 25.32 | 0.4694 | 0.4692 |
| Eco- | | | | | | | |
| Solvent | | | | | | | |
| Inks | | | | | | | |
| TJ Plus/ | T-6500 Reflex | Red | 144 | 15 | 6.29 | 0.6124 | 0.3309 |
| Eco- | (comparative) | | | | | | |
| Solvent | | | | | | | |
| Inks | | | | | | | |
| TJ Plus/ | JG-1 | Red | 115 | 13 | 9.09 | 0.6143 | 0.3377 |
| Eco- | (comparative) | | | | | | |
| Solvent | | | | | | | |
| Inks | | | | | | | |
| TJ Plus/ | TJ-11 | Red | 172 | 20 | 6.83 | 0.6152 | 0.3316 |
| Eco- | | | | | | | |
| Solvent | | | | | | | |
| Inks | | | | | | | |
| TJ Plus/ | T-6500 Reflex | Green | 210 | 22 | 6.70 | 0.1618 | 0.4260 |
| Eco- | (comparative) | | | | | | |
| Solvent | | | | | | | |
| Inks | | | | | | | |
| TJ Plus/ | JG-1 | Green | 138 | 15 | 8.70 | 0.1613 | 0.4128 |
| Eco- | (comparative) | | | | | | |
| Solvent | | | | | | | |
| Inks | | | | | | | |
| TJ Plus/ | TJ-11 | Green | 184 | 21 | 7.88 | 0.1538 | 0.4187 |
| Eco- | | | | | | | |
| Solvent | | | | | | | |
| Inks | | | | | | | |

The results show TJ-11 has similar printing colors for yellow, red, and green inks in comparison to the two comparatives (T-6500 and JG-1), but has much higher reflectivity and contrast factor. The results demonstrate the inventive blend greatly improved ink printability.

### Example 4

T-11500 Reflex (comparative) is an Avery Dennison product that shows good printability for both inks. It is a multilayer film with an inner layer of impact-modified PMMA with top layer of an acrylic copolymer with no impact modifier.

TJ-13 (comparative) is a blend of 99% CA-1000E-2 PMMA with impact modifier with 1% Tinuvin 360 UV absorber and no other additives.

TJ-12 is a blend of 89% CA-1000E-2 PMMA with impact modifier with 10% Kurarity LA4285 acrylic copolymer and 1.0% Tinuvin 360 UV absorber.

The materials were converted into retroreflective sheeting using Avery Dennison's Omnicube tooling.

| | | | | | Daytime | | |
|---|---|---|---|---|---|---|---|
| | | | Average | | Luminance | CIE Color | |
| | Formulation/ | Printed | Ra | Contrast | Factor (Y) | Coordinates | |
| Printer/Ink | Substrate | Color | (cd/lux/m²) | % | Y | x | y |
| No printing | T-11500 Reflex | None | 909 | | 30.29 | 0.2968 | 0.3171 |
| | (comparative/ | | | | | | |
| | control) | | | | | | |
| No printing | TJ-12 | None | 843 | | 28.89 | 0.3015 | 0.3210 |
| | (comparative/ | | | | | | |
| | control) | | | | | | |
| No printing | TJ-13 | None | 894 | | 26.91 | 0.3002 | 0.3199 |
| | (control) | | | | | | |
| | T-11500 Reflex | Yellow | 524 | 58 | 20.41 | 0.4452 | 0.4626 |
| | (comparative) | | | | | | |
| TJ Plus/Eco- | TJ-12 | Yellow | 733 | 87 | 19.50 | 0.4615 | 0.4739 |
| Solvent Inks | (comparative) | | | | | | |
| TJ Plus/Eco- | TJ-13 | Yellow | 543 | 61 | 20.41 | 0.4532 | 0.4699 |
| Solvent Inks | | | | | | | |
| TJ Plus/Eco- | T-11500 Reflex | Red | 180 | 20 | 6.26 | 0.5913 | 0.3380 |
| Solvent Inks | (comparative) | | | | | | |
| TJ Plus/Eco- | TJ-12 | Red | 225 | 27 | 5.83 | 0.6125 | 0.3350 |
| Solvent Inks | (comparative) | | | | | | |
| TJ Plus/Eco- | TJ-13 | Red | 132 | 15 | 7.48 | 0.6088 | 0.3404 |
| Solvent Inks | | | | | | | |
| TJ Plus/Eco- | T-11500 Reflex | Green | 226 | 25 | 7.90 | 0.1669 | 0.4232 |
| Solvent Inks | (comparative) | | | | | | |
| TJ Plus/Eco- | TJ-12 | Green | 238 | 28 | 6.28 | 0.1553 | 0.4315 |
| Solvent Inks | (comparative) | | | | | | |
| TJ Plus/Eco- | TJ-13 | Green | 235 | 26 | 6.77 | 0.1678 | 0.4225 |
| Solvent Inks | | | | | | | |
| TJ Plus/Eco- | T-11500 Reflex | Blue | 153 | 17 | 3.89 | 0.153 | 0.1331 |
| Solvent Inks | (comparative) | | | | | | |
| TJ Plus/Eco- | TJ-12 | Blue | 117 | 14 | 3.12 | 0.138 | 0.1152 |
| Solvent Inks | (comparative) | | | | | | |
| TJ Plus/Eco- | TJ-13 | Blue | 116 | 13 | 3.11 | 0.1435 | 0.1174 |
| Solvent Inks | | | | | | | |

The results show that reflectivity, contrast factor, and color saturation for yellow and red inks dramatically improved by blending the acrylic copolymer (T-12 formulation) with the impact-modified PMMA. For green and blue inks, the color saturation was also improved, especially the night time colors (data not shown).

### Example 5

TJ-14 (comparative) is a blend of 93.75% CA-1000E-2 with 5% Kurarity LA4285, 1.0% Tinuvin P and 0.25% Tinuvin 770.

TJ-17 (comparative) is a blend of 88.75% CA-1000E-2 with 10% Kurarity LA4285, 1.0% Tinuvin P and 0.25% Tinuvin 770.

TJ-18 (comparative) is CA-1000E-2 blended with 1% Tinuvin P with no other additive added.

The materials were converted into retroreflective sheeting using Avery Dennison's Omnicube tooling.

| | Formulation/ | Printed | Color | Color | Ink |
|---|---|---|---|---|---|
| Printer/Ink | substrate | Color | Clarity | Uniformity | adhesion |
| TJ Plus/Eco- | TJ-14 | Yellow | 5 | 5 | 5B |
| Solvent Inks | | | | | |
| TJ Plus/Eco- | TJ-14 | Red | 5 | 5 | 5B |
| Solvent Inks | | | | | |
| TJ Plus/Eco- | TJ-17 | Yellow | 5 | 5 | 5B |
| Solvent Inks | | | | | |
| TJ Plus/Eco- | TJ-17 | Red | 5 | 5 | 5B |
| Solvent Inks | | | | | |
| TJ Plus/Eco- | TJ-18 | Yellow | 3 | 3 | 5B |
| Solvent Inks | | | | | |
| TJ Plus/Eco- | TJ-18 | Red | 3 | 3 | 5B |
| Solvent Inks | | | | | |
| TJ Pro/UV | TJ-14 | Yellow | 5 | 5 | 5B |
| Curable Inks | | | | | |
| TJ Pro/UV | TJ-14 | Red | 5 | 5 | 5B |
| Curable Inks | | | | | |
| TJ Pro/UV | TJ-14 | Green | 5 | 5 | 5B |
| Curable Inks | | | | | |
| TJ Pro/UV | TJ-14 | Black | 5 | 5 | 5B |
| Curable Inks | | | | | |
| TJ Pro/UV | TJ-17 | Yellow | 5 | 5 | 5B |
| Curable Inks | | | | | |
| TJ Pro/UV | TJ-17 | Red | 5 | 5 | 5B |
| Curable Inks | | | | | |
| TJ Pro/UV | TJ-17 | Green | 5 | 5 | 5B |
| Curable Inks | | | | | |
| TJ Pro/UV | TJ-17 | Black | 5 | 5 | 5B |
| Curable Inks | | | | | |
| TJ Pro/UV | TJ-18 | Red | 5 | 5 | 3B |
| Curable Inks | | | | | |
| TJ Pro/UV | TJ-18 | Black | 5 | 5 | 2B |
| Curable Inks | | | | | |

Example 5 shows the improved printability of both Eco-solvent inks and UV curable inks for PMMA blended with an acrylic copolymer. The addition of LA4285 is greatly improving the printed ink clarity and uniformity for solvent inks and ink adhesion for UV curable inks for different color inks.

### Example 6

The improved printability further elaborated by printed color quality and retroreflectivity as shown in the following example. In Example 6, the improved printability further elaborated by printed color quality and retroreflectivity as shown in the table below. TJ-14, TJ-17, and TJ-18 are the same formulations as those in Example 5. TJ-14 on T-6500, TJ-17 on T-6500, and TJ-18 on T-6500 retroreflective sheeting which is the films converted from TJ-14, TJ-17, and TJ-18 laminated on Avery Dennison T-6500 sheeting. For a reference, Avery Dennison T-6500 retroreflective sheeting was also tested with the example compounds. The measurements for color and reflectivity were performed the same way as those in Example 3. The results show that reflectivity, contrast factor, and color saturation for yellow and red inks dramatically improved by blending the copolymer.

| | | | | | Daytime | | |
|---|---|---|---|---|---|---|---|
| | | | | | Luminance | | |
| | | | Average | | Factor | CIE Color | |
| | Formulation/ | Printed | Ra | Contrast | (Y) | Coordinates | |
| Printer/Ink | Substrate | Color | (cd/lux/m²) | % | Y | x | y |
| No printing | T-6500 | None | 558 | — | 46.66 | 0.3095 | 0.3278 |
| No printing | TJ-14 on | None | 546 | — | 44.24 | 0.3128 | 0.3321 |
| | T-6500 | | | | | | |
| No printing | TJ-17 on | None | 550 | — | 46.77 | 0.3117 | 0.3308 |
| | T-6500 | | | | | | |
| No printing | TJ-18 on | None | 554 | — | 44.13 | 0.3118 | 0.3311 |
| | T-6500 | | | | | | |
| TJ Plus/ | T-6500 | Yellow | 305 | 54.7 | 30.44 | 0.4845 | 0.4638 |
| Eco- | | | | | | | |
| Solvent | | | | | | | |
| Inks | | | | | | | |
| TJ Plus/ | T-6500 | Red | 71 | 12.7 | 8.38 | 0.6158 | 0.3302 |
| Eco- | | | | | | | |
| Solvent | | | | | | | |
| Inks | | | | | | | |
| TJ Plus/ | TJ-14 on | Yellow | 303 | 55.5 | 27.9 | 0.4883 | 0.4645 |
| Eco- | T-6500 | | | | | | |
| Solvent | | | | | | | |
| Inks | | | | | | | |
| TJ Plus/ | TJ-14 on | Red | 73 | 13.4 | 7.63 | 0.6268 | 0.3309 |
| Eco- | T-6500 | | | | | | |
| Solvent | | | | | | | |
| Inks | | | | | | | |
| TJ Plus/ | TJ-17 on | Yellow | 307 | 55.8 | 28.06 | 0.489 | 0.4647 |
| Eco- | T-6500 | | | | | | |
| Solvent | | | | | | | |
| Inks | | | | | | | |
| TJ Plus/ | TJ-17 on | Red | 75 | 13.6 | 7.5 | 0.6314 | 0.3301 |
| Eco- | T-6500 | | | | | | |
| Solvent | | | | | | | |
| Inks | | | | | | | |
| TJ Plus/ | TJ-18 on | Yellow | 229 | 41.3 | 29.71 | 0.4872 | 0.4633 |
| Eco- | T-6500 | | | | | | |
| Solvent | | | | | | | |
| Inks | | | | | | | |
| TJ Plus/ | TJ-18 on | Rec | 41 | 7.4 | 8.69 | 0.6181 | 0.3330 |
| Eco- | T-6500 | | | | | | |
| Solvent | | | | | | | |
| Inks | | | | | | | |

The results show that reflectivity, contrast factor, and color saturation for yellow and red inks dramatically improved by blending the copolymer.

When ranges are used herein for physical properties, such as molecular weight, or chemical properties, such as chemical formulae, all combinations, and subcombinations of ranges specific embodiments therein are intended to be included.

The disclosures of each patent, patent application, and publication cited or described in this document are hereby incorporated herein by reference, in their entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

What is claimed is:

1. A printable film, comprising a composition,
wherein the composition comprises:
a polymethyl methacrylate material; and
an acrylic copolymer comprising hard segments and soft segments;
wherein the hard segments comprise polymerized residues of methyl methacrylate; and
wherein the soft segments comprise polymerized residues of a monomer whose homopolymer has a glass transition temperature less than about 50° C.

2. The printable film of claim 1,
wherein the hard segments have a T_{g} of about 100° C. to about 120° C.; and
wherein the soft segments have a T_{g} of about −40° C. to about −60° C.

3. The printable film of claim 1,
wherein the polymethyl methacrylate material is a polymethyl methacrylate homopolymer, a polymethyl methacrylate copolymer, an impact-modified version thereof, or a combination thereof.

4. The printable film of claim 1,
wherein the soft segments comprise polymerized residues of a monomer selected from the group consisting of butyl acrylate, 2-ethylhexyl acrylate, and combinations thereof.

5. The printable film of claim 1,
wherein the acrylic copolymer is present at a level of about 2% by weight, based on the total weight of the composition, to about 40% by weight, based on the total weight of the composition.

6. The printable film of claim 1,
wherein the acrylic copolymer is a block copolymer of methyl methacrylate and butyl acrylate.

7. The printable film of claim 1,
wherein the hard segments are present in the acrylic copolymer at a level of about 35% by weight, based on the total weight of the acrylic copolymer, to about 55% by weight, based on the total weight of the acrylic copolymer.

8. The printable film of claim 1,
wherein the acrylic copolymer is a tri-block copolymer.

9. The printable film of claim 1,
wherein the acrylic copolymer is a di-block copolymer.

10. The printable film of claim 1,
wherein the acrylic copolymer is non-crystalline.

11. A retroreflective sheet, comprising:
a first layer comprising the printable film of claim 1; and
a second layer disposed on the first layer;
wherein the second layer comprises:
a plurality of retroreflective elements.

12. The retroreflective sheet of claim 11, further comprising:
a pressure sensitive adhesive located on the second layer on a side opposite to the first layer; and
an optional release liner on the pressure sensitive adhesive.

13. The retroreflective sheet of claim 11, further comprising:
printed indicia on the printable layer; and
an optional overlaminate layer provided over at a portion of the printed indicia.

14. The retroreflective sheet of claim 11,
wherein the plurality of retroreflective elements are micro prisms.

15. The retroreflective sheet of claim 11,
wherein the retroreflective elements are shapes selected from a group consisting of triangles, squares, rectangles, hexagons, and combinations thereof.

16. The retroreflective sheet of claim 11,
wherein the plurality of retroreflective elements are micro beads.

17. A retroreflective sign, comprising:
a sign blank;
the retroreflective sheet of claim 11;
wherein the retroreflective sheet is applied to the sign blank; and
wherein the retroreflective sheet further comprises:
printed indicia on the first layer; and
a pressure sensitive adhesive located on the second layer on a side opposite to the first layer.

18. A method of improving print quality of a printable film, comprising the steps:
providing a composition comprising:
an polymethyl methacrylate material; and
an acrylic copolymer comprising hard segments and soft segments;
wherein the hard segments comprise polymerized residues of methyl methacrylate; and
wherein the soft segments comprise polymerized residues of a monomer whose homopolymer has a glass transition temperature less than about 50° C.; and
forming a film from the composition.

19. The method of claim 19, further comprising:
printing the film with an ink selected from the group consisting of at least one solvent-based ink, at least one UV-curable ink, and combinations thereof.

20. The method of claim 19, further comprising:
laminating the film with an embossing layer; and
embossing the embossing layer with micro prisms to form a retroreflective sheet.

21. The method of claim 19, further comprising:
providing a layer comprising micro beads;
laminating the film with the layer to form a retroreflective sheet.
